(19) United States
(12) Patent Application Publication
(10) Pub. No.: US 2012/0209963 A1
(43) Pub. Date: Aug. 16, 2012

(54) APPARATUS, METHOD, AND COMPUTER PROGRAM FOR DYNAMIC PROCESSING, SELECTION, AND/OR MANIPULATION OF CONTENT

(75) Inventors: Atul Patel, Irvine, CA (US); Patrick Ting, Duarte, CA (US)

(73) Assignee: OneScreen Inc., Irvine, CA (US)

(21) Appl. No.: 13/368,218

(22) Filed: Feb. 7, 2012

Related U.S. Application Data
(60) Provisional application No. 61/441,617, filed on Feb. 10, 2011.

(51) Int. Cl. G06F 15/16

(52) U.S. Cl. 709/219

(57) ABSTRACT

An apparatus, method, and a computer program are configured to dynamically process and select content from a webpage. Content data in a webpage may be identified and alternative video content may be determined for the identified content. Content may then be replaced with alternative video content when alternative video content is available for the content.

### CROSS-REFERENCE TO RELATED APPLICATION

This application claims the benefit of U.S. Provisional Patent Application No. 61/441,167, filed on Feb. 10, 2011. The subject matter thereof is hereby incorporated herein by reference in its entirety.

### FIELD

The present invention generally relates to processing and selecting content and, more particularly, to dynamically processing, selecting and swapping content with alternative content.

### BACKGROUND

Many website publishers display content, such as audio, video, and images, on one or more pages of their website. For instance, a webpage may display two or three music videos. However, the content displayed on the one or more pages of the website may not be generating revenue for the publisher, the publisher may not have the rights to display the content, and/or may not be compatible with the user's web browser. In addition, the content displayed on the one or more pages may not be able to provide the user with an enhanced experience when visiting the one or more pages of the website.

### SUMMARY

Certain embodiments of the present invention may provide solutions to the problems and needs in the art that have not yet been fully identified, appreciated, or solved by current systems that process and select content on one or more pages of a website.

One or more embodiments relate to an apparatus, method, and computer program configured to dynamically process and select content from a webpage. Content in a webpage is identified and alternative video content is determined for the identified content. Content is replaced with the alternative video content when the alternative video content is available for the content.

In accordance with an embodiment of the present invention, a computer-implemented method is provided. The method includes transmitting an identification of content to a server, and receiving alternative content from the server for content that is to be replaced on a webpage. The method also includes swapping replaceable content with the alternative content.

In accordance with another embodiment of the present invention, an apparatus is provided. The apparatus includes a communication device configured to transmit an identification of content to a server and receive alternative content from the server for content that is to be replaced on a webpage. The processor is also configured to swap replaceable content with the alternative content.

In accordance with another embodiment of the present invention, a computer-implemented method is provided. The method includes receiving content of a webpage from a host server when the webpage is accessed, based on the received content, determining content that is to be replaced on the webpage, and swapping replaceable content with alternative content based on the determination of the content that is to be replaced. The method also includes transmitting the alternative content of the webpage to a client device.

In accordance with another embodiment of the present invention, an apparatus is provided. The apparatus includes a communication device configured to receive content of a webpage from a host server when the webpage is accessed and a processor configured to determine content that is to be replaced on the webpage based on the received content. The processor is further configured to swap replaceable content with alternative content based on the determination of the content that is to be replaced. The communication device is further configured to transmit the alternative content of the webpage to a client device.

### BRIEF DESCRIPTION OF THE DRAWINGS

For a proper understanding of the invention, reference should be made to the accompanying figures. These figures depict only some embodiments of the invention and are not limiting of the scope of the invention. Regarding the figures:

FIG. 1 illustrates a block diagram of a system configured to process content, in accordance with one or more embodiments of the present invention.

FIG. 2 illustrates a method for indexing and identifying alternative video content on a webpage, in accordance with one or more embodiments of the present invention.

FIG. 3 illustrates a method for determining alternative video content, in accordance with one or more embodiments of the present invention.

FIG. 4 illustrates a method for determining whether a webpage has been indexed, in accordance with one or more embodiments of the present invention.

FIG. 5 illustrates a method for identifying and swapping video content, in accordance with one or more embodiments of the invention.

FIG. 6 illustrates a system configured to process content, in accordance with one or more embodiments of the present invention.

FIG. 7 illustrates a system configured to process content, in accordance with one or more embodiments of the present invention.

FIG. 8 illustrates a method for replacing and swapping content with alternative video content, in accordance with one or more embodiments of the present invention.

### DETAILED DESCRIPTION OF THE EMBODIMENTS

It will be readily understood that the components of the invention, as generally described and illustrated in the figures herein, may be arranged and designed in a wide variety of different configurations. Thus, the following detailed description of the embodiments is not intended to limit the scope of the invention as claimed, but is merely representative of selected embodiments of the invention.

The features, structures, or characteristics of the invention described throughout this specification may be combined in any suitable manner in one or more embodiments. For example, the usage of “certain embodiments,” “some embodiments,” or other similar language, throughout this specification refers to the fact that a particular feature, structure, or characteristic described in connection with an embodiment may be included in at least one embodiment of the invention. Thus, appearances of the phrases “in certain embodiments,” “in some embodiments,” “in other embodiments,” or other similar language, throughout this specification do not necessarily all refer to the same embodiment or group of embodiments, and the described features, structures, or characteristics may be combined in any suitable manner in one or more embodiments.

One or more embodiments described herein relate to a tool that can be integrated into a third-party website. The third-party website may belong to a content publisher. The tool can be a JavaScript-based software tool that allows an operator of the tool to swap displayed images, MP3 files, video content, or any other data on a website with similar or identical content.

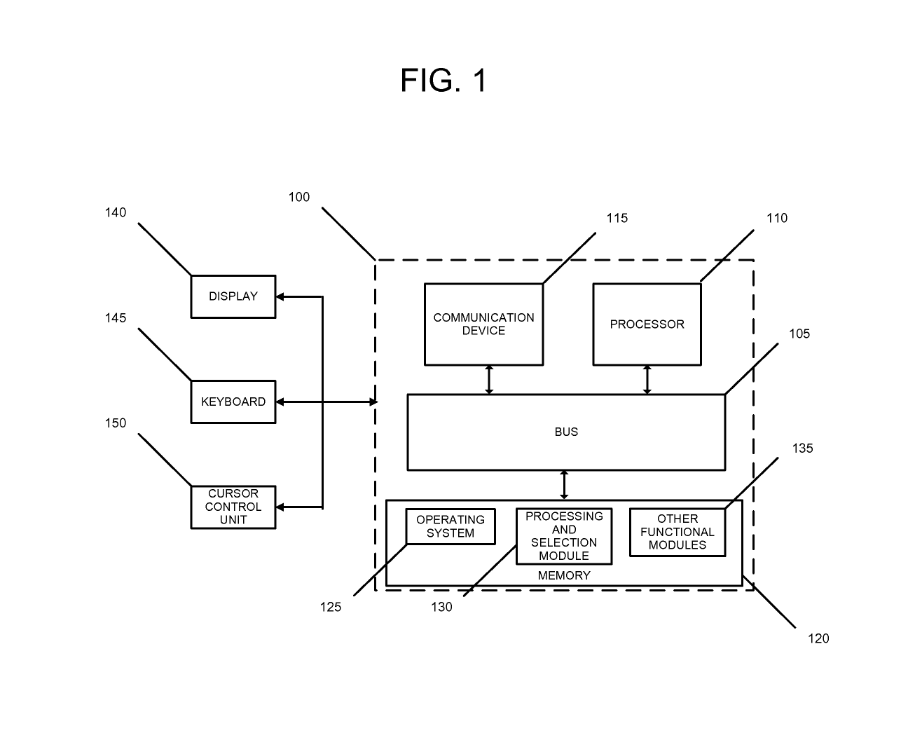

FIG. 1 illustrates a block diagram of a system 100 configured to process content, in accordance with one or more embodiments of the present invention. System 100 may include a bus 105 or other communication mechanism that can communicate information and a processor 110, coupled to bus 105, that can process information. Processor 110 can be any type of general or specific purpose processor. System 100 may also include a memory 120 that can store information and instructions to be executed by processor 110. Memory 120 can be comprised of any combination of random access memory (“RAM”), read only memory (“ROM”), static storage such as a magnetic or optical disk, or any other type of computer readable medium. System 100 may also include a communication device 115, such as a network interface card, that may provide access to a network.

The computer readable medium may be any available media that can be accessed by processor 110. The computer readable medium may include both volatile and nonvolatile medium, removable and non-removable media, and communication media. The communication media may include computer readable instructions, data structures, program modules, or other data and may include any information delivery media.

Processor 110 can also be coupled via bus 105 to a display 140, such as a Liquid Crystal Display (“LCD”). Display 140 may display information to the user, such as an operator or content publisher. A keyboard 145 and a cursor control unit 150, such as a computer mouse, may also be coupled to bus 105 to enable the user to interface with system 100.

According to one embodiment, memory 120 may store software modules that may provide functionality when executed by processor 110. The modules can include an operating system 125 and a processing and selection module (i.e., a tool) 130, as well as other functional modules 135. Operating system 125 may provide operating system functionality for system 100. Because system 100 may be part of a larger system, system 100 may include one or more additional functional modules 135 to include the additional functionality.

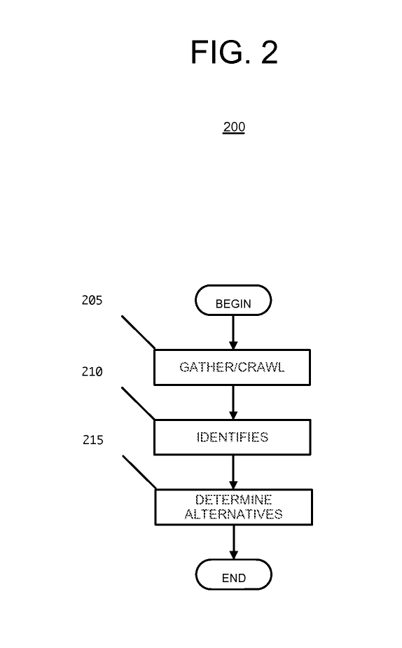

FIG. 2 illustrates a method 200 for indexing and identifying alternative video content on a webpage, in accordance with one or more embodiments of the present invention. In this embodiment, each webpage may include a JavaScript processing and selection tool, or any other suitable implementation of the processing and selection module (tool). The JavaScript can cause, at 205, either a client server or an intermediary server (e.g., OneScreen^{SM} server) to gather, or crawl for, information regarding content on a webpage using a crawler. For instance, the crawler may search for patterns or content such as images, MP3 files, videos that are linked to YouTube® videos, and a Rovi™ database. The crawler may also search for any other content data, as would be readily appreciated by a person of ordinary skill in the art. A person of ordinary skill in the art will also readily appreciate that the data gathered from the webpage may be stored on the client server, the intermediary server, or both. Based on the gathered data, image data, MP3 data, and/or video content data are identified at 210 and alternative video content data that is similar or identical to the image data, MP3 data, and/or video content data is determined at 215.

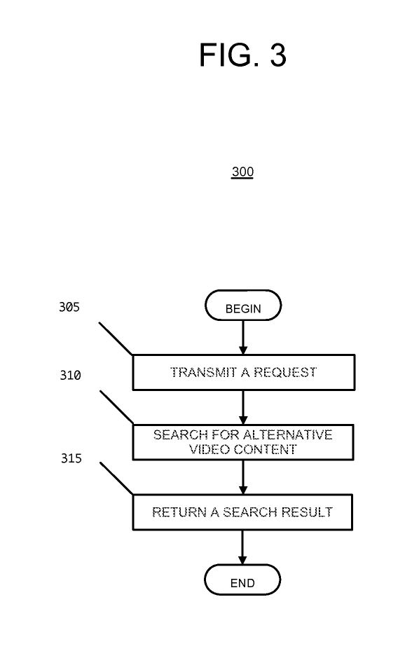

FIG. 3 illustrates a method 300 for determining alternative video content, in accordance with one or more embodiments of the present invention. While the method illustrated in FIG. 3 is directed to determining alternative video content, in other embodiments, the method can be customized to determine alternative data, such as alternative image content, alternative audio content, etc. In this embodiment, in order to determine the alternative video content, JavaScript embedded within the code of the webpage is configured to transmit at 305 a request to the intermediary server. The request identifies which content should be replaced or swapped. Based on the request, the intermediary server searches at 310 an intermediary server database for the alternative video content. Based on the search, the intermediary server is configured to return a result at 315 identifying the alternative video content.

The alternative video content can include revenue generating content, licensed content, alternative format content, etc. However, a person of ordinary skill in the art will readily appreciate that the alternative video content can be stored not only on the intermediary server, but also on a client server or any remote server.

Revenue-generating content is video content that generates revenue for the host or publisher. Many websites, for example, include video content that does not generate any revenue for the host or publisher. However, if the video content is swapped with the revenue generating content, then the publisher or host can generate revenue from playing the video content on the website. Licensed content is video content that is cleared by the owner of the content. For instance, many websites can include content that infringes someone's copyright. However, by swapping potentially infringing content or non-licensed content with licensed content (i.e., content that the site has the right to provide), a website owner may be able to avoid potential legal disputes.

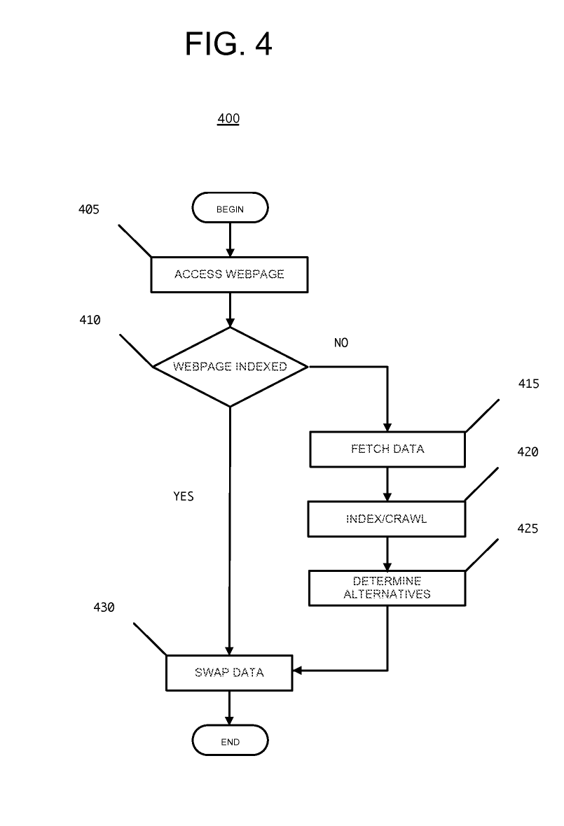

FIG. 4 illustrates a method 400 for determining whether a webpage has been indexed, in accordance with one or more embodiments of the present invention. At 405, a user accesses a webpage. At 410, an intermediary server is configured to determine whether the webpage being accessed has been indexed. In one embodiment, if the webpage has not been previously indexed, then the content of the webpage is fetched at 415 from the client server. The intermediary server is configured to index at 420 the content of the webpage and alternative video content is identified or determined at 425. Based on the identified alternative video content, the content of the webpage is swapped or replaced at 430 with the identified alternative video content.

For instance, if the publisher of a website adds a new webpage, JavaScript embedded within the code of the webpage allows the intermediary server to determine whether the new webpage has been indexed. If the new webpage has not been indexed, the intermediary server, for example, is configured to store information gathered from the webpage in a separate database for indexing at a later time. This allows the alternative content to be found for the content on the webpage when the alternative content is available. Because most websites are driven by a Content Management System (CMS), the publisher of the website only needs to include the JavaScript in a single webpage and every other webpage will include the JavaScript.

However, if the webpage has been indexed for alternative video content, then content of the webpage is replaced with alternative video content at 430. Because the webpage has been indexed, alternative video content is already identified on the intermediary server. This allows the content to be seamlessly swapped with the alternative video content. As a result, when the user of the webpage views an image or video on the webpage, alternative content of the same or a similar type seamlessly replaces the image or video and displays the alternative video content on the webpage to enhance the user's experience of the webpage, as well as allows the publisher of the webpage to generate revenue.

It should be appreciated that the alternative video content can replace the content, can be an overlay of the content, or can be displayed in any other manner that would be appreciated by a person of ordinary skill in the art. It should also be appreciated that the content being replaced or swapped can be chosen by a publisher of the webpage. For instance, the publisher can tag content in one or more pages that the publisher wishes to replace. In the alternative, all of the content in one or more pages can be selected to be replaced or swapped with alternative video content. In another embodiment, the content selected to be swapped may be based on the user or viewer of the webpage.

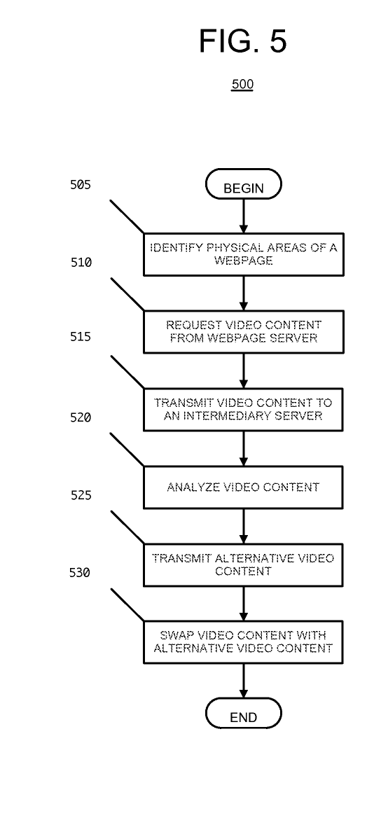

FIG. 5 illustrates a method 500 for identifying and swapping video content, in accordance with one or more embodiments of the present invention. In this embodiment, a JavaScript-based software tool is embedded in website code or a webpage. At 505, the tool is configured to identify different physical areas on the webpage. For example, the physical areas can be video content (e.g., denoted by a “Div” tag in some embodiments) or any content appreciated by a person of ordinary skill in the art denoted in any desired manner. In another embodiment, the tool can crawl the webpage to determine tags associated with the replaceable content on the webpage. The tool may also be configured to identify video content by code snippets that represents the video content, or code snippets which would otherwise generate a Div tag for the display of video content. For example, Javascript code, upon execution, can cause a Div tag to be generated. It should be appreciated that, based on the code snippet, the tool can identify all video content or selected video content on the webpage. At 510, the tool is configured to gather the relevant code snippets for each Div tag, for example, on the webpage by transmitting a request for video content to a webpage server. Video content or information regarding the relevant code snippets is transmitted at 515 to an intermediary server (i.e., OneScreen^{SM} Server). The information can be transmitted in the form of a sequence of characters.

The server at 520 is configured to analyze the code snippets or video content against the server's database for similar and/or identical video content. If similar and/or identical video content is found, the server at 525 transmits video content replacement information to a website (or webpage) server. Based on the video content replacement information, the video content as displayed on the website is swapped or replaced by the tool at 530 with the similar and/or identical video content. It should be appreciated that the similar and/or identical content can have the functionality to display advertising content along with the desired video content.

The tool allows a publisher of content to address two primary goals/issues which many publishers of video content face: (1) avoiding conduct which may be construed as copyright infringement, i.e., displaying video content which the publisher does not have a right to provide, and/or (2) monetizing the publisher's website or websites by replacing non-revenue-generating video content with revenue-generating video content.

For instance, the tool addresses the risk of copyright infringement in a “preventative” and “curative” manner, because publishers cannot always police the video content that is displayed on their websites. As such, video content may be subject to “take-down” notices and requests by third parties who assert their copyrights for the video content. Assuming publishers comply with such requests, the publisher will be left without video content, and in particular/all of that located in its Div tags. As a result, there may be adverse economic consequences for the publisher, such as loss of subsequent advertising revenue, which would have been earned by the display of advertising content along with the particular video content.

The tool operator (e.g., OneScreen^{SM}), however, having previously obtained all the necessary copyrights to similar and/or identical video content stored within its own database, can deliver such replacement video content to the publisher, and thereby allow the publisher to mitigate its losses following take-downs of video content. If the tool is implemented on the publisher's website, and assuming such relevant video content exists in the tool operator's database(s), the video content intended for display within its Div tags would be “replaced” by identical video content delivered through the operator's media player. The tool in this context acts to prevent potential copyright disputes with third-party content owners, assuming that the tool operator has all the necessary rights to distribute, copy, modify, etc. the delivered video content.

The tool allows publishers to better “monetize”, or generate advertising revenue, from their websites when the display of video content is paired with advertising content. It should be noted that publishers often turn to User-Generated Content (“UGC”) to fill their website Divs. However, publishers do not generate any advertising revenue from displaying such UGC video content, unless there are Divs separately devoted to advertising content. By modifying and delivering replacement video content, which is similar or identical to UGC video content through the tool, publishers are able to capture additional advertising revenue through advertising that may be attached to the video content in a video “pre-roll”.

The tool can provide other functionality to content owners or publishers with their own proprietary players, as the tool is intended to identify and target the content itself. The tool operator may contact such video content owners in the event that relevant similar or identical video content is not found within the tool operator's databases with the appropriate licensing rights to display the owned content. Any advertising “embedded” in such third-party video content would receive more hits from end-users of publisher websites, resulting in a mutually beneficial situation for content owners and publishers. Assuming that the tool operator maintains all necessary rights, licenses, and the like to display the video content within its network/database, the increased monetization can be realized for publishers and video content owners without the risk of take-down due to copyright issues.

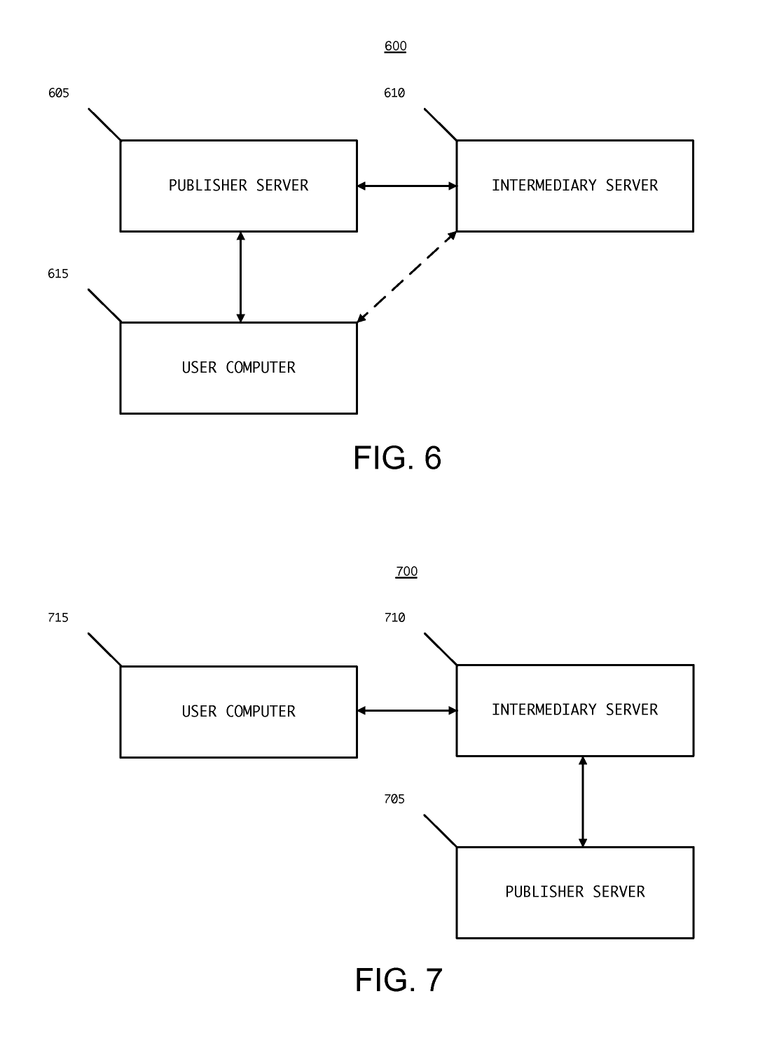

FIG. 6 illustrates a system 600 configured to process content, in accordance with one or more embodiments of the present invention. The system 600 illustrates a publisher server (or host server) 605, an intermediary server 610, and a user computer 615. It should be appreciated that the publisher server 605, the intermediary server 610, and the user computer 615 may include similar components to those shown in FIG. 1.

The publisher server 605 hosts or includes one or more websites, each website having one or more webpages. The intermediary server 610 is configured to store a copy of content of each webpage and is configured to gather information regarding content on each webpage to identify alternative video content. The intermediary server 610 also includes a database including alternative video content.

When a user accesses a webpage using a user computer 615 or when a webpage loads, in one embodiment, JavaScript embedded within the webpage can be configured to transmit a request to the intermediary server 610 for alternative video content. In an alternative embodiment, a host server can periodically transmit the request to intermediary server 610. The request can be made, for example, using a library that can perform a Hypertext Transfer Protocol (HTTP) request. In an alternative embodiment, the user computer 615 can directly transmit the request to the intermediary server 610 via a flash proxy or iframe, and bypass the publisher server 605. The request can also include content that needs to be replaced with alternative video content. As mentioned above, the publisher may predefine the content that needs to be replaced. In the alternative, the intermediary server 610 can be configured to select which content needs to be replaced and swap or replace the content with alternative video content.

The intermediary server 610 receives the request and, for the content to be replaced, alternative video content is identified. The intermediary server 610 may return a result in a JavaScript payload, an HTML payload, or through any medium that would be appreciated by a person of ordinary skill in the art. For example, the HTML payload identifies which part of the webpage the alternative video content should be inserted into, and which part of the webpage the content should be removed from. It should be appreciated that the intermediary server 610 is configured to transmit the alternative video content to the publisher server 605. The JavaScript is then configured to swap content with the alternative video content.

FIG. 7 illustrates a system 700 configured to process content, in accordance with one or more embodiments of the present invention. The system includes a publisher server 705, an intermediary server 710, and a user computer 715. In this embodiment, the intermediary server 710 can serve as a Content Delivery Network (CDN).

For instance, when a user computer 715 accesses a webpage, the intermediary server 710 is configured to pull content from the publisher server 705, which stores content of the webpage. The intermediary server 710 is then configured to index the content of the webpage and identify any content that can be replaced by alternative video content. It should be appreciated that the publisher can configure the intermediary server 710 to select, index, and identify which content should be replaced. If any of the content can be replaced by alternative video content, then the intermediary server 710 is configured to determine the alternative video content for the identified content. Based on the determination, the intermediary server 710 is configured to swap the identified content with the alternative video content in the webpage. The intermediary server 710 is then configured to transmit updated content of the webpage to the user computer 715.

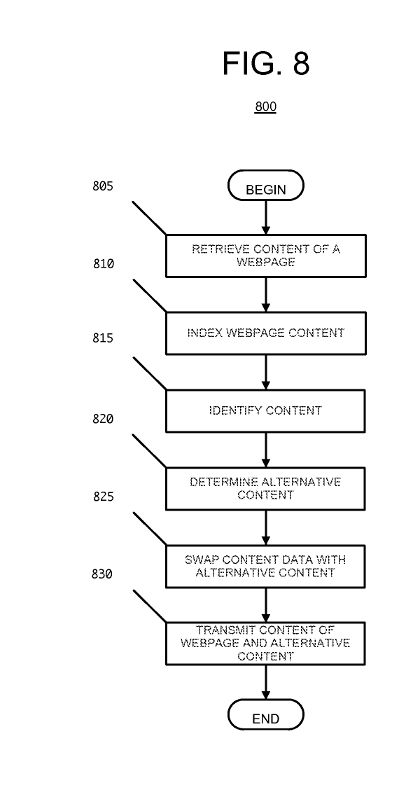

FIG. 8 illustrates a method 800 for replacing and swapping content with alternative video content, in accordance with one or more embodiments of the present invention. At 805, content of a webpage is retrieved from a publisher server when a user computer loads a webpage. At 810, the content of the webpage is indexed and, at 815, content that may be replaced by alternative video content is identified. For the content that is identified, alternative video content is determined at 820. Based on the determination, the identified content is swapped or replaced at 825 with alternative video content. At 830, the webpage with the alternative video content is transmitted to the user computer.

The method steps shown in FIGS. 2-5 and 8 may be performed, at least in part, by a computer program product, encoding instructions for a nonlinear adaptive processor to cause at least the methods described in FIGS. 2-5 and 8 to be performed by the apparatuses discussed herein. The computer program product may be embodied on a non-transitory computer readable medium. The computer readable medium may be, but is not limited to, a hard disk drive, a flash device, a random access memory, a tape, or any other such medium used to store data. The computer program product may include encoded instructions for controlling the nonlinear adaptive processor to implement the method described in FIGS. 2-5 and 8, which may also be stored on the computer readable medium.

The computer program product can be implemented in hardware, software, or a hybrid implementation. The computer program product can be composed of modules that are in operative communication with one another, and which are designed to pass information or instructions to display. The computer program product can be configured to operate on a general purpose computer, or an Application Specific Integrated Circuit (“ASIC”).

In accordance with an embodiment of the present invention, a computer-implemented method is provided. The method includes identifying replaceable content when a webpage is accessed, transmitting an indication of the replaceable content to another server, and receiving alternative content for the replaceable content. The method also includes swapping the replaceable content with the alternative content.

In accordance with another embodiment of the present invention, the replaceable content includes video data, image data, and/or audio data.

In accordance with another embodiment of the present invention, the alternative content includes alternative video content that is similar to the replaceable content displayed on the webpage.

In accordance with another embodiment of the present invention, the method also includes identifying physical areas of the webpage, where the physical areas include the replaceable content.

In accordance with another embodiment of the present invention, the replaceable content is identified by a code snippet.

In accordance with another embodiment of the present invention, the transmitting to the other server includes transmitting the indication of the replaceable content in a sequence of characters.

In accordance with another embodiment of the present invention, an apparatus is provided. The apparatus includes a processor configured to identify replaceable content when a webpage is accessed, and a communication device configured to transmit an indication of the replaceable content to another server and receive alternative content for the replaceable content. The processor is also configured to swap the replaceable content with the alternative content.

In accordance with another embodiment of the present invention, the replaceable content includes video data, image data, and/or audio data.

In accordance with another embodiment of the present invention, the alternative content includes alternative video content that is similar to the replaceable content displayed on the webpage.

In accordance with another embodiment of the present invention, the processor is further configured to identify physical areas of the webpage, where the physical areas include the replaceable content.

In accordance with another embodiment of the present invention, the replaceable content is identified by a code snippet.

In accordance with another embodiment of the present invention, the communication device is configured to transmit the identification of the replaceable content in a sequence of characters to the other server.

In accordance with another embodiment of the present invention, a computer-implemented method is provided. The method includes receiving content of a webpage from a host server when the webpage is accessed, determining whether the content of the webpage is indexed, and, when the content of the webpage is indexed, swapping content with corresponding alternative content. The method also includes transmitting the content of the webpage with the corresponding alternative content.

In accordance with another embodiment of the present invention, the content includes image data, audio data, and/or video data.

In accordance with another embodiment of the present invention, the corresponding alternative content includes alternative video content that is similar to the content displayed on the webpage.

In accordance with another embodiment of the present invention, the method also includes, when the content of the webpage is not indexed, indexing the content of the webpage to identify the content.

In accordance with another embodiment of the present invention, the method also includes comparing the identified content with the corresponding alternative content.

In accordance with another embodiment of the present invention, an apparatus is provided. The apparatus includes a communication device configured to receive content of a webpage from a host server when the webpage is accessed and a processor configured to determine whether the content of the webpage is indexed. When the content of the webpage is indexed, the processor is further configured to swap content with corresponding alternative content. The communication device is further configured to transmit the content of the webpage with the corresponding alternative content.

In accordance with another embodiment of the present invention, the content includes image data, audio data, and/or video data.

In accordance with another embodiment of the present invention, the corresponding alternative content includes alternative video content that is similar to the content displayed on the webpage.

In accordance with another embodiment of the present invention, when the content of the webpage is not indexed, the processor is further configured to index the content of the webpage to identify the content.

In accordance with another embodiment of the present invention, the processor is further configured to compare the identified content with the corresponding alternative content.

One having ordinary skill in the art will readily understand that the invention as discussed above may be practiced with steps in a different order, and/or with hardware elements in configurations that are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A computer-implemented method, comprising:
transmitting an identification of content to a server;
receiving alternative content from the server for content that is to be replaced on a webpage; and
swapping replaceable content with the alternative content.

2. The computer-implemented method of claim 1, wherein the identification of the content comprises a specific region of the webpage, the entire webpage, or one or more portions of the webpage.

3. The computer-implemented method of claim 1, wherein the replaceable content comprises video data, image data, and/or audio data.

4. The computer-implemented method of claim 1, wherein the alternative content comprises content similar to the replaceable content that is displayed on the webpage.

5. The computer-implemented method of claim 1, further comprising:
crawling the webpage to determine tags associated with the replaceable content on the webpage.

6. The computer-implemented method of claim 1, wherein the replaceable content is identified by a code snippet.

7. The computer-implemented method of claim 1, wherein the transmitting to the server comprises transmitting the identification of the content in a sequence of characters.

8. An apparatus, comprising:
a communication device configured to transmit an identification of the content to a server and receive alternative content from the server for content that is to be replaced on a webpage; and
a processor configured to swap the replaceable content with the alternative content.

9. The apparatus of claim 8, wherein the identification of the content comprises a specific region of the webpage, the entire webpage, or one or more portions of the webpage.

10. The apparatus of claim 8, wherein the replaceable content comprises video data, image data, and/or audio data.

11. The apparatus of claim 8, wherein the alternative content comprises content similar to the replaceable content displayed on the webpage.

12. The apparatus of claim 8, wherein the processor is further configured to crawl the webpage to determine tags associated with the replaceable content on the webpage.

13. The apparatus of claim 8, wherein the replaceable content is identified by a code snippet.

14. The apparatus of claim 8, wherein the communication device is further configured to transmit the identification of the content in a sequence of characters to the server.

15. A computer-implemented method, comprising:
receiving content of a webpage from a host server when the webpage is accessed;
based on the received content, determining content that is to be replaced on the webpage;
swapping replaceable content with alternative content based on the determination of the content that is to be replaced; and
transmitting the alternative content of the webpage to a client device.

16. The computer-implemented method of claim 15, wherein the content comprises image data, audio data, and/or video data.

17. The computer-implemented method of claim 15, wherein the alternative content comprises content that is similar to the replaceable content that is displayed on the webpage.

18. The computer-implemented method of claim 15, wherein the determining of the content that is to be replaced comprises:
comparing the received content with available content,
wherein the available content is stored in a database.

19. The computer-implemented method of claim 18, wherein the determining of the content that is to be replaced further comprises:
identifying the replaceable content based on the comparison of the received content with the available content.

20. An apparatus, comprising:
a communication device configured to receive content of a webpage from a host server when the webpage is accessed; and
a processor configured to determine content that is to be replaced on the webpage based on the received content,
wherein the processor is further configured to swap replaceable content with alternative content based on the determination of the content that is to be replaced, and
the communication device is further configured to transmit the alternative content of the webpage to a client device.

21. The apparatus of claim 20, wherein the content includes image data, audio data, and/or video data.

22. The apparatus of claim 20, wherein the alternative content comprises content that is similar to the replaceable content displayed on the webpage.

23. The apparatus of claim 20, wherein the processor is further configured to compare the received content with available content, and the available content is stored in a database.

24. The apparatus of claim 23, wherein the processor is further configured to identify the replaceable content based on the comparison of the received content and the available content.
